(19) United States
(12) Patent Application Publication
(10) Pub. No.: US 2007/0274181 A1
(43) Pub. Date: Nov. 29, 2007

(54) Digital audio signal reproducing device

(75) Inventor: Yi-Chuan Yao, Tainan Hsien (TW)

Correspondence Address: KAMRATH & ASSOCIATES P.A., 4825 OLSON MEMORIAL HIGHWAY, SUITE 245, GOLDEN VALLEY, MN, 55422, US

(73) Assignee: YA HORNG ELECTRONIC CO., LTD., Tainan Hsien (TW)

(21) Appl. No.: 11/439,107

(22) Filed: May 23, 2006

(51) Int. Cl. G11B 19/00

(52) U.S. Cl. 369/47.38; 369/31.01

(57) ABSTRACT

A digital audio signal reproducing device includes a system processor, a first rotation disk, a second rotation disk, a first sensor, a second sensor, and a lighting assembly. The first sensor detects rotation speed and direction of the first rotation disk to output a first control signal. The second sensor detects the second rotation disk being pressed to output a second control signal. When the first control signal and the second control signal are outputted to the system processor simultaneously, the lighting assembly is controlled by the system processor to perform a first blinking mode, and when only the first control signal is outputted to the system processor, the lighting assembly is controlled by the system processor to perform a second blinking mode.

### BACKGROUND OF THE INVENTION

1. Field of the Invention

The present invention relates to a reproducing device and, more particularly, to a digital audio signal reproducing device.

2. Description of the Related Art

In general, the DJ (disk jockey) in the pub or the like often operates the analogue record player to reproduce diversified sounds. When the analogue record is placed on the turntable, the stylus reads the audio information recorded in the analogue record. When the analogue record is manipulated by a user's hand to change its rotation direction and rotation speed, the music at the normal state is interrupted and the output of sound becomes a scratch sound. Therefore, the user can employ a scratch operation by changing the rotation direction and speed of the analogue record to output a scratch sound to enhance the amusement. After the user's hand is removed from the analogue record, the output of a scratch sound stops, and the music restarts at the normal state.

Furthermore, the DJ may perform another operation, as called the “pitchbend” operation, in which the analogue record is turned at a higher or lower speed than the predetermined RPM while the analogue record is being reproduced by the analogue record player. By employing this pitchbend operation, the DJ is enabled to vary the reproducing speed of the audio information so that the reproducing speed matches to that of the audio information being reproduced by another analogue record player. When these reproducing speeds match, the two pieces of audio information can be switched without any disorder feel by switching the audio information being reproduced from another analogue record player to the audio information reproduced at the adjusted reproducing speed.

Nowadays, A digital audio signal player that reproduces digital audio information can be operated by simulating the scratch and pitchbend operations of the analogue record player. The digital audio signal player includes a turntable and a select key to switch the scratch and pitchbend operation modes. When the user pushes the select key to select the scratch operation mode and then rotates the turntable, the outputted sound is a scratch sound. Next, when the user pushes the switching key to select the pitchbend operation mode and then rotates the turntable, the speed of outputted sound is different from the predetermined speed. In such a manner, the user, however, needs to manually switch the select key to exchange the scratch and pitchbend operation modes, thereby causing inconvenience to the user's operation activity.

### BRIEF SUMMARY OF THE INVENTION

In accordance with the present invention, there is provided a digital audio signal reproducing device including a servo controller which controls a drive member to rotate a digital disc and controls a reader to read a digital audio information recorded in the digital disc. The digital audio information is amplified by a high frequency amplifier, demodulated by a signal processor and stored in a memory by control of a memory controller. The digital audio signal reproducing device further includes a system processor, an operation assembly including a first rotation disk and a second rotation disk, a first sensor detecting rotation speed and direction of the first rotation disk to output a first control signal indicating the rotation speed and direction of the first rotation disk, a second sensor detecting the second rotation disk being pressed to output a second control signal indicating the second rotation disk being pressed, and a lighting assembly including a plurality of light emitting members. When the first control signal and the second control signal are outputted to the system processor simultaneously, the lighting assembly is controlled by the system processor to perform a first blinking mode, and when only the first control signal is outputting to the system processor, the lighting assembly is controlled by the system processor to perform a second blinking mode.

The primary objective of the present invention is to provide a digital audio signal reproducing device that can read the digital audio information recorded in a digital disc to proceed a sound reproduction and can visually indicate the proceeding operation mode by a light blinking action.

Another objective of the present invention is to provide a digital audio signal reproducing device that simulates the same manipulations of the analogue record player.

A further objective of the present invention is to provide a digital audio signal reproducing device that directly exchanges the scratch and pitchbend operation modes without pushing any select key.

A further objective of the present invention is to provide a digital audio signal reproducing device, wherein the operation modes of the digital audio signal reproducing device are indicated by different blinking modes.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a block diagram of a digital audio signal reproducing device in accordance with the preferred embodiment of the present invention.

FIG. 2 is a plan view of the digital audio signal reproducing device in accordance with the preferred embodiment of the present invention.

FIG. 3 is a plan cross-sectional view of an operation assembly of the digital audio signal reproducing device in accordance with the preferred embodiment of the present invention.

FIG. 4 is a plan cross-sectional view of a second sensor of the digital audio signal reproducing device in accordance with the preferred embodiment of the present invention.

FIG. 5 is a flow chart of the digital audio signal reproducing device in accordance with the preferred embodiment of the present invention.

### DETAILED DESCRIPTION OF THE INVENTION

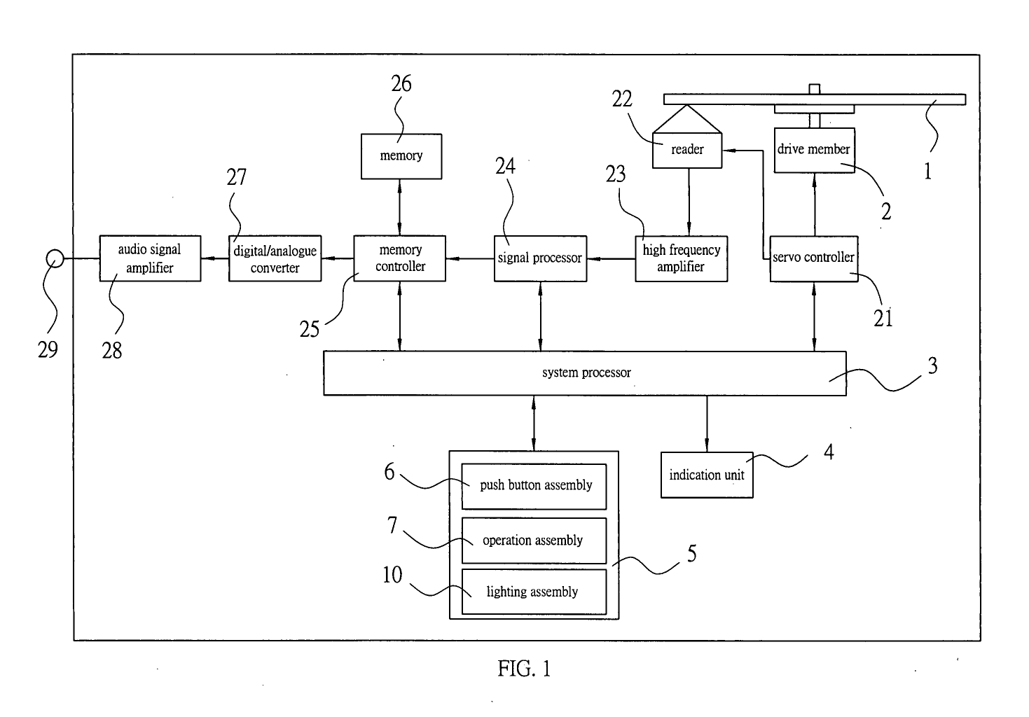

Referring to the drawings and initially to FIGS. 1-4, a digital audio signal reproducing device in accordance with the preferred embodiment of the present invention comprises a drive member 2, a servo controller 21, a reader 22, a high frequency amplifier 23, a signal processor 24, a memory controller 25, a memory 26, a digital/analogue converter 27, an audio signal amplifier 28, an output terminal 29, a system processor 3, an indication unit 4, and a control unit 5.

A digital disc 1 (such as a compact disc) is placed on the drive member 2. When the control unit 5 sends a reproduction signal to the system processor 3, the system processor 3 delivers the related order to the servo controller 21 which controls the drive member 2 to rotate the digital disc 1 at a constant linear speed and controls the reader 22 to move and read the digital audio information recorded in the digital disc 1. The digital audio information read by the reader 22 is amplified by the high frequency amplifier 23 and then is sent to the signal processor 24 for demodulation and error correction. The processed digital audio information is further controlled by the memory controller 25 and sent to the memory 26. Meanwhile, the digital audio information stored in the memory 26 can be read out by control of the memory controller 25 and then sent to the digital/analogue converter 27 which converts the digital audio information from digital format to analogue format for the purpose of output from the output terminal 29.

The indication unit 4 receives the message from the system processor 3 to indicate the related notices such as reproducing time, number and speed of the digital audio information that is being reproduced.

The control unit 5 includes a push button assembly 6, an operation assembly 7, and a lighting assembly 10.

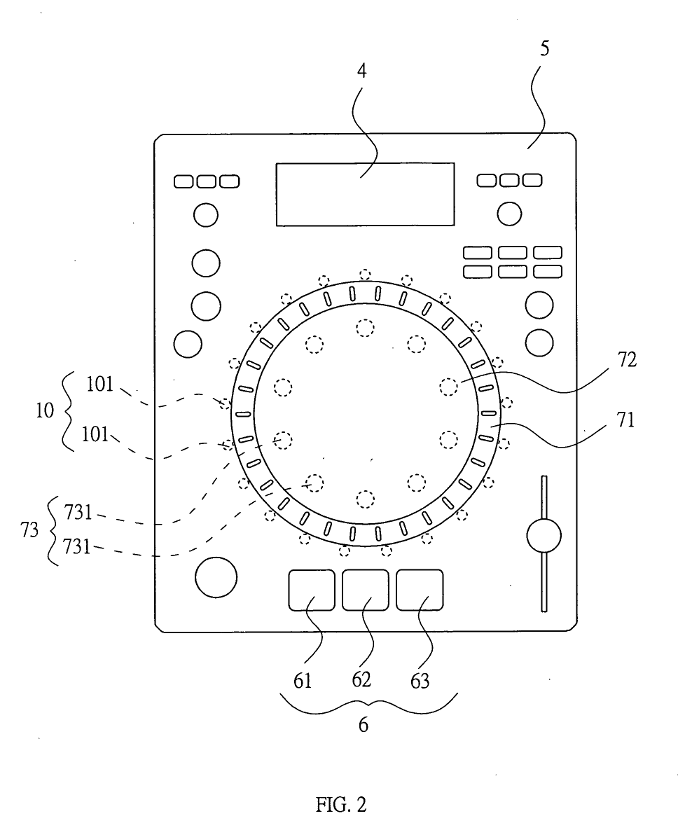

As shown in FIG. 2, the push button assembly 6 has multiple push buttons that at least provide a disc start button 61, a disc stop button 61, and a disc eject button 63.

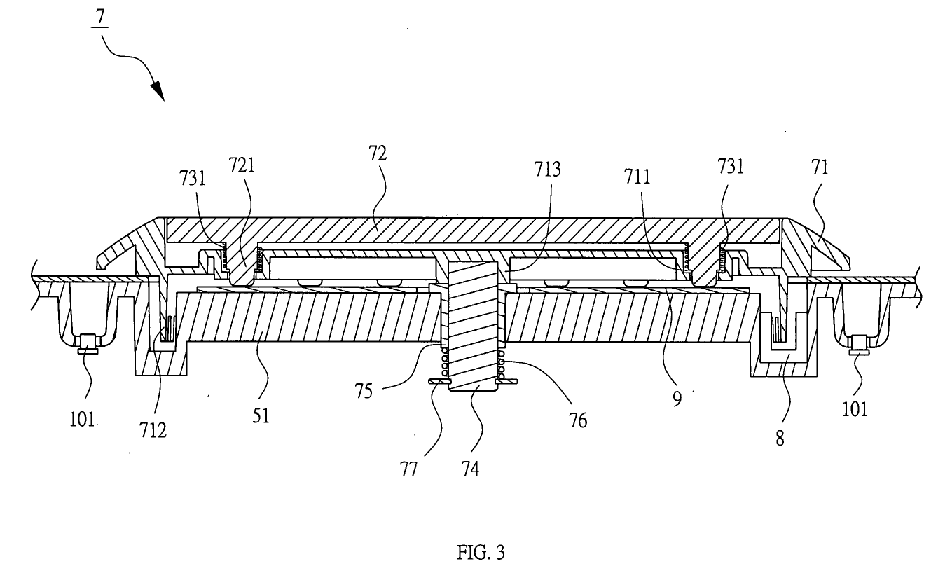

As shown in FIG. 3, the operation assembly 7 is mounted on a frame 51 of the control unit 5 and includes a first rotation disk 71, a second rotation disk 72, and an elastic portion 73. The first rotation disk 71 has a bottom formed with a plurality of through holes 711 and has a periphery provided with a downward protruding plate formed with a slit portion 712. The second rotation disk 72 has a bottom formed with a plurality of downward protruding press rods 721 each penetrating through the respective through holes 711 of the first rotation disk 71. The elastic portion 73 comprises a plurality of elastic members 731 each mounted on the respective press rod 721 of the second rotation disk 72.

The operation assembly 7 further includes a rotation shaft 74 which rotatably penetrates a bushing 75 mounted on the frame 51 and having its upper end secured to the central portion 713 of the first rotation disk 71 to rotate therewith, a retainer 77 secured on the lower end of the rotation shaft 74 to rotate therewith, and an elastic anti-slip member 76 mounted on the rotation shaft 74 and pressed between the retainer 77 and the bottom of the bushing 75 to provide a friction to the retainer 77 to limit rotation of the first rotation disk 71. The central portion 713 of the first rotation disk 71 has its bottom rested on the upper end of the bushing 75 to function as a rotation fulcrum of the first rotation disk 71.

The second rotation disk 72 is located above the first rotation disk 71, and the elastic portion 73 is mounted between the first rotation disk 71 and the second rotation disk 72 to prop up the second rotation disk 72 to keep an elastic distance from the first rotation disk 71. When the second rotation disk 72 is pressed by a pressing force to overcome the elastic force of the elastic portion 73, it gradually approaches the first rotation disk 71. On the contrary, when the pressing force on the second rotation disk 72 is gone, the elastic force of the elastic portion urges the second rotation disk 72 away from the first rotation disk 71.

A first sensor 8 secured on the frame 51 has two optical detection members that detect the passage of the slit portion 712 of the first rotation disk 71 for the purpose of detecting the rotation speed and direction of the first rotation disk 71. When the first sensor 8 detects passage of the slit portion 712 of the first rotation disk 71, the two optical detection members of the first sensor 8 output a first impulse signal “a” and a second impulse signal “b” with phase differential (e.g., the phase differential of the two impulse signals is 90 degrees) to the system processor 3. For clarity, the impulse signals “a” and “b” produced by the first sensor 8 are called a first control signal.

The system processor 3 judges the rotation direction of the first rotation disk 71 according to the phase differential of the two impulse signals “a” and “b”. For example, the phase differential of the two impulse signals “a” and “b” is 90 degrees. Thus, when the first rotation disk 71 is rotated clockwise, the phase differential of the two impulse signals “a” and “b” is +90 degrees, and when the first rotation disk 71 is rotated counterclockwise, the phase differential of the two impulse signals “a” and “b” is −90 degrees. In addition, the system processor 3 judges the rotation speed of the first rotation disk 71 according to the impulse number of either the impulse signal “a” or the impulse signal “b” of the input first control signal at a determined time.

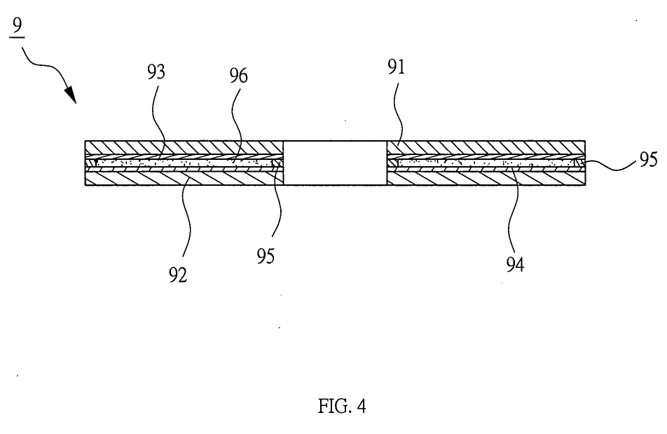

A second sensor 9 preferably is a contact switch. The second sensor 9 is secured on the frame 51 and located under the first rotation disk 71. As shown in FIG. 4, the second sensor 9 has a film shape and includes a flexible upper surface layer 91, an upper conducting layer 93 mounted on the bottom of the upper surface layer 91, a flexible lower surface layer 92 spaced from the upper surface layer 91, a lower conducting layer 94 mounted on the top of the lower surface layer 92, an insulating fluid layer 96 located between the upper conducting layer 93 and the lower conducting layer 94 to provide an insulating effect, and an insulating glue 95 located between the upper conducting layer 93 and the lower conducting layer 94 to encompass the insulating fluid layer 96. When the upper surface layer 91 is pressed downward, the upper conducting layer 93 is electrically connected to the lower conducting layer 94 to produce a trigger signal which is transmitted to the system processor 3, and when the upper surface layer 91 is released, the upper conducting layer 93 is separated and isolated from the lower conducting layer 94 by the insulating fluid layer 96, thereby stopping the trigger signal.

In such a manner, when the second rotation disk 72 is pressed down, the press rods 721 of the second rotation disk 72 touch and press the upper surface layer 91 of the second sensor 9 downward, so that the upper conducting layer 93 is electrically connected to the lower conducting layer 94 to produce a trigger signal to the system processor 3. Next, when the pressing force on the second rotation disk 72 is gone, the second rotation disk 72 is elastically lifted and spaced from the first rotation disk 71 by the pushing of the elastic portion 73 to detach the press rods 721 of the second rotation disk 72 from the upper surface layer 91 of the second sensor 9, and then the upper conducting layer 93 is separated and isolated from the lower conducting layer 94 by the insulating fluid layer 96, thereby stopping producing the trigger signal. For clarity, the trigger signal produced by the second sensor 9 when the second rotation disk 72 is pressed to touch the second sensor 9 is called a second control signal.

The lighting assembly 10 includes a plurality of light emitting members 101 mounted on the frame 51 and enclosed around the periphery of the first rotation disk 71.

During operation, when the first rotation disk 71 is rotated to trigger the first sensor 8 and the second rotation disk 72 is pressed down to trigger the second sensor 9 at the same time, the first control signal produced by the first sensor 8 and the second control signal produced by the second sensor 9 are outputted to the system processor 3 simultaneously. The system processor 3 then controls the memory controller 25 based on the determined rotation speed and rotation direction of the first rotation disk 71. The memory controller 25 controls the readout speed and readout sequence (readout of the digital audio information either by the ascending or descending order of the addresses) of the digital audio information stored in the memory 26. For example, when the first rotation disk 71 is rotated faster than the predetermined speed, the system processor 3 controls the memory controller 25 to accelerate the readout speed of the digital audio information from the memory 26. On the contrary, when the first rotation disk 71 is rotated slower than the predetermined speed, the system processor 3 control the memory controller 25 to slow the readout speed of the digital audio information from the memory 26. Meanwhile, when the first rotation disk 71 is rotated clockwise, the digital audio information stored in the memory 26 is read out in an ascending sequence. On the contrary, when the first rotation disk 71 is rotated counterclockwise, the digital audio information stored in the memory 26 is read out in a descending sequence.

As the manipulation of simultaneously outputting the first and the second signal let the memory controller 25 control the readout speed and readout sequence of the digital audio information stored in the memory 26 on the basis of the rotation speed and rotation direction of the first disk 71, the scratch sound is outputted. Under such so-called scratch operation mode, the lighting assembly 10 shows a first blinking mode by control of the system processor 3, so that a user can visually inspect the scratch operation mode by the first blinking mode.

In addition, when the first rotation disk 71 is rotated to trigger the first sensor 8 and the second rotation disk 72 is not pressed down to trigger the second sensor 9, only the first control signal is produced by the first sensor 8 and outputted to the system processor 3. In such a manner, the system processor 3 then controls the memory controller 25 based on the determined rotation direction of the rotation disk 71. The memory controller 25 controls the readout speed of the digital audio information stored in the memory 26 to be faster or lower than the predetermined speed. For example, when the first rotation disk 71 is rotated clockwise, the digital audio information stored in the memory 26 is readout by the memory controller 25 at a speed faster than the predetermined speed. On the contrary, when the first rotation disk 71 is rotated counterclockwise, the digital audio information stored in the memory 26 is readout by the memory controller 25 at a speed slower than the predetermined speed.

As the manipulation of only outputting the first signal let the memory controller 25 control the readout speed of the digital audio information stored in the memory 26 on the basis of the rotation direction of the first disk 71, the reproducing speed of sound can be faster or slower than the predetermined speed. Under such so-called pitchbend operation mode, the lighting assembly 10 shows a second blinking mode by control of the system processor 3, so that the user can visually inspect the pitchbend operation mode by the second blinking mode.

Moreover, before the first control signal and the second control signal are outputted to the system processor 3, the digital audio information is outputted at the normal reproducing state. When the digital audio signal reproducing device is played at the normal reproducing operation mode, the lighting assembly 10 shows a third blinking mode by control of the system processor 3, so that the user can visually inspect the normal reproducing operation mode by the third blinking mode. Especially, the third blinking mode can be arranged to perform a blinking show according to the beat speed of the normal reproducing digital audio information. For example, the light emitting members 101 of the lighting assembly 10 are controlled by the system processor 3 to blink in turn serially toward a fixed direction to perform a ring-shaped blinking mode according to the beat speed of the normal reproducing digital audio information.

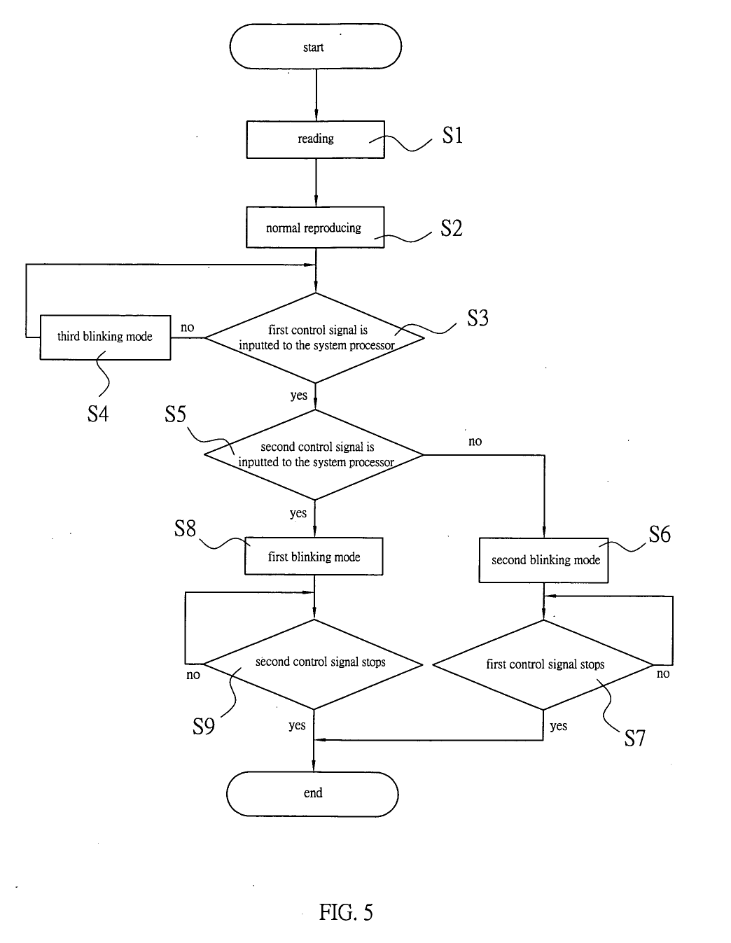

Referring to FIG. 5, the selection mechanism of blinking modes of the lighting assembly 10 is described as follows.

First, the reader 22 is controlled by the system processor 3 to read the digital audio information recorded in the disc 1, and the memory controller 25 is controlled by the system processor 3 to send the digital audio information to the memory 26 (step S1). Before the first control signal is inputted to system processor 3, the digital audio signal reproducing device plays at the normal reproducing operation mode to keep the digital audio information being read out at a predetermined speed (step S2).

When the first control signal is not inputted to the system processor 3 under the situation of the first rotation disk 71 not being rotated (step S3, no), the digital audio signal reproducing device is played at the normal reproducing state, and the lighting assembly 10 is controlled by the system processor 3 to show a third blinking mode (step S4).

On the other way, when the first control signal is inputted to the system processor 3 under the situation of the first rotation disk 71 being rotated (step S3, yes), it further judges if the second control signal is inputted to the system processor 3 under the situation of the second rotation disk being pressed (step S5).

As the second control signal is not sent to the system processor 3 (step S5, no), the system processor 3 only receives the first control signal to keep the digital audio signal reproducing device to play at the pitchbend operation mode, and the lighting assembly 10 is controlled by the system processor 3 to show a second blinking mode (step S6). If the first rotation disk 71 is still rotated by user's hand to generate the first control signal, the show of the second blinking mode keeps on (step S7, no), while the first control signal stops due to the halt of the first rotation disk 71, the show of the second blinking mode of the lighting assembly 10 stops to end immediately (step S7, yes).

On the contrary, As the second control signal is sent to the system processor 3 (step S5, yes), the system processor 3 receives the first and second control signals simultaneously to keep the digital audio signal reproducing device to play at the scratch operation mode, and the lighting assembly 10 is controlled by the system processor 3 to show a first blinking mode (step S8). If the second rotation disk 72 is still rotated by user's hand to generate the second control signal, the show of the first blinking mode keeps on (step S9, no), while the second control signal stops due to the halt of the second rotation disk 72, the show of the first blinking mode of the lighting assembly 10 stops to end immediately (step S9, yes).

Accordingly, the system processor 3 can judge whether the first control signal and the second control signal are outputted to the system processor 3 by operation of the first rotation disk 71 and the second rotation disk 72 to determine the normal reproducing, scratch, and pitchbend operation modes of the digital audio information and can control the lighting assembly 10 to produce different blinking modes to correspond to the normal reproducing, scratch, and pitchbend operation modes of the digital audio information, so that the digital audio signal reproducing device can simulate the manipulation of the analogue record player, thereby facilitating the user's operating the digital audio signal reproducing device.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A digital audio signal reproducing device comprising:
a reader which reads the digital audio information recorded in a digital disc;
a memory controller which send said digital audio information to a memory;
an operation assembly which includes a first rotation disk and a second rotation disk;
a first sensor which detects the rotation speed and direction of said first rotation disk and outputs a first control signal indicating said rotation speed and said rotation direction;
a second sensor which detects said second rotation disk being pressed and outputs a second control signal indicating the pressing;
a lighting assembly which includes a plurality of light emitting members;
a system processor which controls said lighting assembly to perform a first blinking mode on the basis of simultaneously receiving the input of said first and second control signals, and which controls said lighting assembly to perform a second blinking mode on the basis of only receiving the input of said first control signal.

2. The digital audio signal reproducing device in accordance with claim 1, wherein said second rotation disk is rotatable in concert with said first rotation.

3. The digital audio signal reproducing device in accordance with claim 1, wherein said light emitting members of said lighting assembly are enclosed around the periphery of said first rotation disk.

4. The digital audio signal reproducing device in accordance with claim 1, wherein said lighting assembly is controlled by said system processor to perform a third blinking mode before said first control signal is inputted to said system processor.

5. The digital audio signal reproducing device in accordance with claim 4, wherein said third blinking mode has its blinking speed corresponding to the beat speed of said digital audio information when being reproduced.

6. The digital audio signal reproducing device in accordance with claim 4, wherein said third blinking mode has a blinking speed that is quicker than the beat speed of said digital audio information when being reproduced.

7. The digital audio signal reproducing device in accordance with claim 1, wherein said second rotation disk is located above said first rotation disk and propped up by an elastic portion to keep an elastic distance from said first rotation disk.

8. The digital audio signal reproducing device in accordance with claim 6, wherein said elastic portion is mounted between said first rotation disk and said second rotation disk.

9. The digital audio signal reproducing device in accordance with claim 8, wherein said first rotation disk has a surface formed with at least one through hole, and the second rotation disk is correspondingly provided with at least one protruding press rod to penetrate said through hole.

10. The digital audio signal reproducing device in accordance with claim 9, wherein said elastic portion comprises at least one elastic member mounted on said press rod.

11. The digital audio signal reproducing device in accordance with claim 1, wherein said operation assembly further includes a rotation shaft having its upper end secured to the central portion of said first rotation disk to rotate therewith, and an elastic anti-slip member mounted on the bottom of said rotation shaft.

12. The digital audio signal reproducing device in accordance with claim 1, wherein said first rotation disk has a periphery provided with a downward protruding plate formed with a slit portion.

13. The digital audio signal reproducing device in accordance with claim 12, wherein said first sensor has two optical detection members to detect the passage of said slit portion of said first rotation disk.

14. The digital audio signal reproducing device in accordance with claim 1, wherein said second sensor is a contact switch.

15. The digital audio signal reproducing device in accordance with claim 14, wherein said second sensor has a film shape and further includes a flexible upper surface layer, an upper conducting layer mounted on the bottom of said upper surface layer, a flexible lower surface layer spaced from said upper surface layer, a lower conducting layer mounted on the top of said lower surface layer, an insulating fluid layer located between said upper conducting layer and said lower conducting layer to provide an insulating effect, and an insulating glue located between said upper conducting layer and said lower conducting layer to encompass said insulating fluid layer.
